(19) United States
(12) Patent Application Publication
(10) Pub. No.: US 2026/0217253 A1
(43) Pub. Date: Jul. 30, 2026

(54) EVENT-BASED VEHICLE MODE SWITCHING FOR A VEHICLE

(71) Applicant: Textron Inc., Providence, RI (US)

(72) Inventors: Cole Elliott O'Brien, North Augusta, SC (US); Preston Sering Easley, Martinez, GA (US)

(73) Assignee: Textron Inc., Providence, RI (US)

(21) Appl. No.: 19/036,770

(22) Filed: Jan. 24, 2025

(51) Int. Cl. B60W 30/182; B60K 35/81; B60W 50/08; G07C 5/00; H04W 4/021

(52) U.S. Cl. CPC B60W 30/182; B60K 35/81; B60W 50/082; G07C 5/008; H04W 4/021; B60W 2300/405

(57) ABSTRACT

A vehicle system includes at least one processing circuit having at least one processor and at least one memory having instructions stored thereon that, when executed by the at least one processor, cause the at least one processor to detect a trigger event associated with a golf course while a personal vehicle of a user is in a first vehicle mode. The instructions further cause the at least one processor to transition the personal vehicle from the first vehicle mode to a second vehicle mode associated with the golf course based on detecting the trigger event. The personal vehicle has a first set of functionalities while in the first vehicle mode and a second set of functionalities while in the second vehicle mode, the second set of functionalities being different than the first set of functionalities and corresponding to at least one rule associated with the golf course.

### BACKGROUND

Off-road machines or vehicles are used in various scenarios for a variety of purposes. For example, all-terrain vehicles (“ATVs”) and utility task vehicles (“UTVs”) may be used for off-road exploration or performing a variety of tasks requiring off-road capabilities. Other lightweight or recreational machines (e.g., golf carts, lawnmowers, other chore products) can be used in a variety of other contexts to perform specific chores or to make travel between different locations more convenient.

### SUMMARY

One embodiment relates to a vehicle system. The vehicle system includes at least one processing circuit having at least one processor and at least one memory having instructions stored thereon that, when executed by the at least one processor, cause the at least one processor to detect a trigger event associated with a golf course while a personal vehicle of a user is in a first vehicle mode. The instructions, when executed by the at least one processor, further cause the at least one processor to transition the personal vehicle from the first vehicle mode to a second vehicle mode associated with the golf course based on detecting the trigger event. The personal vehicle has a first set of functionalities while in the first vehicle mode and a second set of functionalities while in the second vehicle mode, the second set of functionalities being different than the first set of functionalities and corresponding to at least one rule associated with the golf course.

Another embodiment relates to a vehicle system. The vehicle system includes a vehicle display device configured to be installed on a personal vehicle of a user. The vehicle display device includes at least one processing circuit having at least one processor and at least one memory having instructions stored thereon that, when executed by the at least one processor, cause the at least one processor to display a first user interface associated with a first vehicle mode while the personal vehicle is in the first vehicle mode. The instructions, when executed by the at least one processor, further cause the at least one processor to detect a trigger event associated with a golf course. The instructions, when executed by the at least one processor, further cause the at least one processor to cause the personal vehicle to transition from the first vehicle mode to a second vehicle mode associated with the golf course based on detecting the trigger event, the personal vehicle having a first set of functionalities while in the first vehicle mode and a second set of functionalities while in the second vehicle mode, the second set of functionalities being different than the first set of functionalities and corresponding to at least one rule associated with the golf course. The instructions, when executed by the at least one processor, further cause the at least one processor to display a second user interface associated with the second vehicle mode while the personal vehicle is in the second vehicle mode.

Still another embodiment relates to a vehicle system of a vehicle. The vehicle system includes at least one processing circuit having at least one processor and at least one memory having instructions stored thereon that, when executed by the at least one processor, cause the at least one processor to detect a trigger event associated with a golf course while a vehicle of a user is in a personal use mode, wherein the vehicle is not trackable and not controllable by the golf course in the personal use. The instructions, when executed by the at least one processor, further cause the at least one processor to transition the vehicle from the personal use mode to a golf mode associated with the golf course based on detecting the trigger event, wherein the vehicle is at least one of trackable or controllable by the golf course in the golf mode. The at least one processing circuit includes at least one of (a) a first processing circuit configured to be located on the vehicle or (b) a second processing circuit configured to be located remote from the vehicle.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is another schematic block diagram of the vehicle of FIG. 1, according to an exemplary embodiment.

FIG. 4 is a schematic block diagram of a fleet monitoring and control system including a plurality of the vehicles of FIG. 1, according to an exemplary embodiment.

FIG. 5 is a personal use mode vehicle user interface, according to an exemplary embodiment.

FIG. 6 is the personal use mode vehicle user interface of FIG. 5, showing a dropdown menu of selectable options, according to an exemplary embodiment.

FIG. 7 is a golf mode vehicle user interface, according to an exemplary embodiment.

FIG. 8 is the golf mode vehicle user interface of FIG. 7, showing a dropdown menu of selectable options, according to an exemplary embodiment.

FIG. 9 is a golf course management user interface, according to an exemplary embodiment.

FIG. 10 is a flowchart of a method for acquiring golf mode information, according to an exemplary embodiment.

FIG. 11 is a flowchart of a method for switching between a personal use mode and a golf mode, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

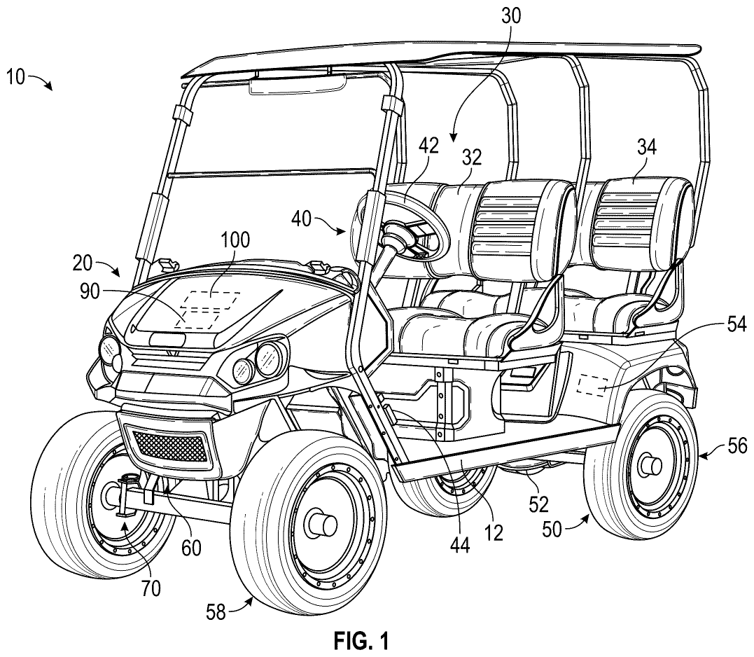

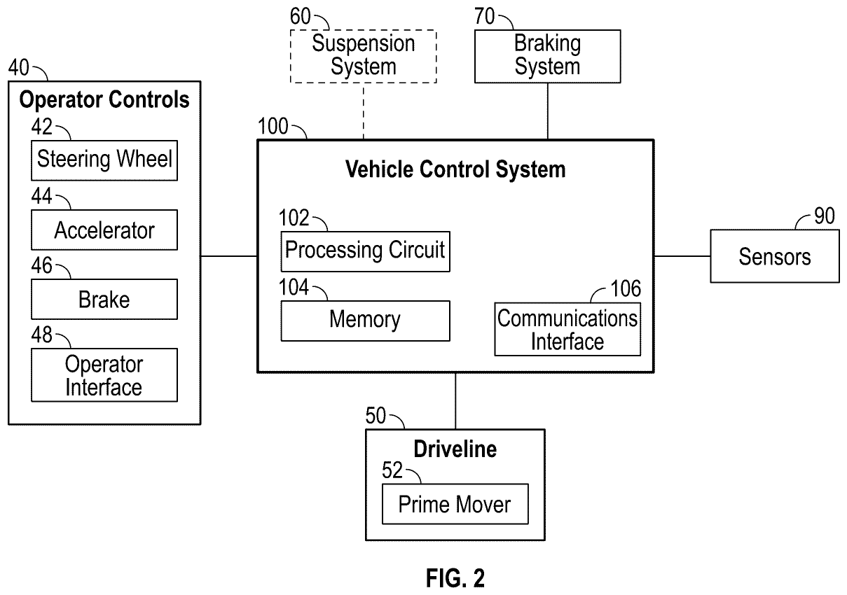

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart or vehicle, an all-terrain vehicle (“ATV”), a utility task vehicle (“UTV”), a low speed vehicle (“LSV”), a personal transport vehicle (“PTV”), a hauler, and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, another type of chore product that may be used on a golf course, a ground support equipment (“GSE”) that may be used at an airport, and/or still other off-road machines or vehicles.

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. In some embodiments, the operator interface 48 may include one or more displays and one or more input devices. The one or more displays may be or include a touchscreen, a LCD display, a LED display, a speedometer, gauges, warning lights, etc. The one or more input devices may be or include buttons, switches, knobs, levers, dials, etc. In some instances, the operator interface 48 may be initially provided separate from the vehicle 10. In these instances, the operator interface 48 may be remotely operable (e.g., remote from the vehicle 10) and may be installed within, electronically and communicatively coupled to, and mounted on the vehicle 10 to place the operator interface 48 in communication with the various systems and components of the vehicle 10 and to allow for the operator of the vehicle 10 to view and interact with various user interfaces, as will be described in further detail below.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor (e.g., the motor 53) and the energy storage 54 is a battery system (e.g., the battery module 57, the add-on battery module(s) 59, etc.). In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 70 to facilitate braking of one or more components of the driveline 50.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, a Doppler sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Electrified Driveline

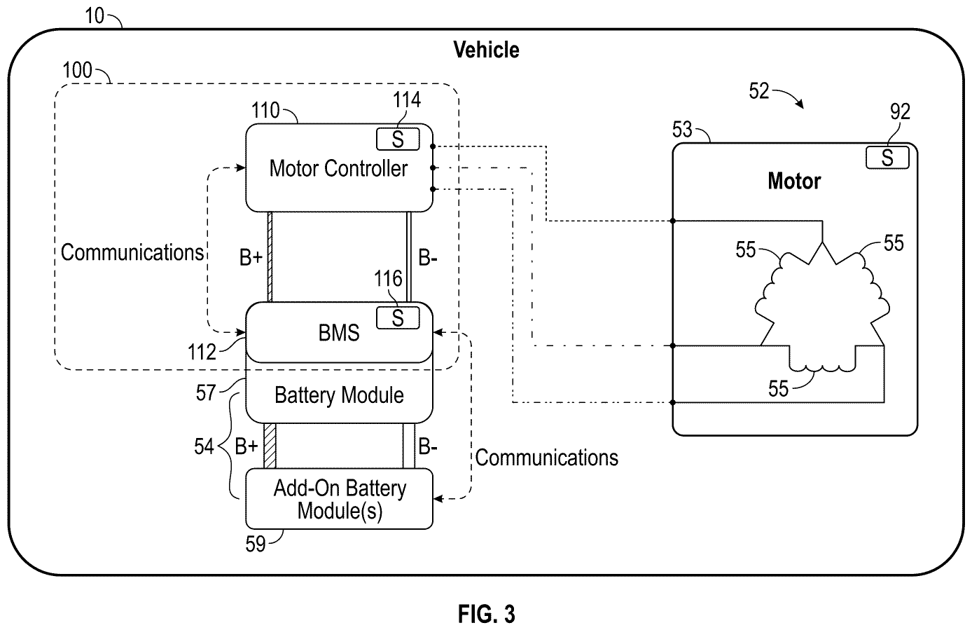

According to the exemplary embodiments shown in FIG. 3, the driveline 50 of the vehicle 10 is configured as an electrified driveline where (a) the prime mover 52 is configured as a three-phase, alternating current (“AC”) electric motor, shown as motor 53, including three sets of windings, shown as motor windings 55, and a first sensor, shown as motor sensor 92; (b) the energy storage 54 is configured as a battery system including a first battery pack or module, shown as battery module 57, and one or more second battery packs or modules, shown as add-on battery module(s) 59, electrically coupled to the battery module 57 in parallel; and (c) the vehicle control system 100 includes (i) a first controller, shown as motor controller 110, coupled to the motor 53 and including a second sensor, shown as motor controller sensor 114, and (ii) a second controller, shown as battery management system (“BMS”) 112, coupled to the motor controller 110 and the energy storage 54 (e.g., the battery system, the battery module 57, the add-on battery module(s) 59, etc.) and including a third sensor, shown as BMS sensor 116. In some embodiments, the motor 53 is configured as a separately excited DC motor. The motor sensor 92, the motor controller sensor 114, and/or the BMS sensor 116 may include a temperature sensor, a voltage sensor, a current sensor, a speed sensor, and/or another suitable sensor to facilitate monitoring at least one of the operational parameters (e.g., temperature, voltage, current, speed, SOC, rate of charge, rate of discharge, etc.) of the motor 53, the motor controller 110, the BMS 112, the battery module 57, and/or the add-on battery modules(s) 59. The motor controller 110 and the BMS 112 may each include a processing circuit 102, a memory 104, and a communications interface 106.

According to an exemplary embodiment, each of the battery module 57 and the add-on battery module(s) 59 of the battery system includes one or more rows and/or groups of battery cells. The BMS 112 may be configured to monitor characteristics of the rows and/or groups of battery cells and/or individual cells of the battery module 57 and the add-on battery module(s) 59 (e.g., using data acquired by the BMS sensor 116) including, but not limited to, voltage, temperature, current, and state of charge (“SOC”). The BMS 112 may also be configured to provide direct current (“DC”) power from the battery system to the motor controller 110 to power the motor 53 based on driving demands of the vehicle 10.

According to an exemplary embodiment, the motor controller 110 is configured to manage the power supplied to the motor 53. By way of example, the motor controller 110 may be configured to modulate the voltage, current, phase, and/or frequency of the power sent to the motor windings 55, which can influence the torque and speed output provided by the motor 53. In some embodiments, the motor controller 110 is configured to control a type of power, AC power or DC power, delivered to the motor 53. By way of example, the motor controller 110 may be configured to convert the type of power from DC power to AC power and/or regulate the AC power or DC power depending on the intended function of the motor 53. The motor controller 110 may include components to invert, convert, or otherwise modulate DC power and/or AC power.

As shown in FIG. 3, the energy storage 54 is configured to supply (e.g., via electrical wiring, electrical connections, etc.) DC power to the motor controller 110. In some embodiments, the DC power flows from the energy storage 54, through the BMS 112, and to the motor controller 110. The BMS 112 and the motor controller 110 may include communication interfaces (e.g., communications interfaces 106) that facilitate exchanging data related to operational status, command signals, and feedback therebetween. The BMS 112 and the add-on battery module 59 (e.g., a BMS thereof) may include communication interfaces that facilitate exchanging data related to operational status, command signals, and feedback therebetween. The add-on battery module(s) 59 is(are) configured to provide additional battery cells and increase the total energy storage capacity of the energy storage 54. As shown in FIG. 3, the battery module 57 and the add-on battery module(s) 59 are connected in parallel (e.g., via wires, connection busses, etc.) to provide for a pathway of electrical transfer. In other embodiments, the battery module 57 and the add-on battery module(s) 59 are connected in series.

According to an exemplary embodiment, the BMS 112 is configured to monitor (e.g., continuously, periodically, etc.) various parameters of the energy storage 54, including voltage, current, and temperature of each cell, rows/groups, and/or module within the energy storage 54. In some embodiments, the BMS 112 is configured to calculate or otherwise determine the SOC of the energy storage 54, the battery module 57, and/or the add-on battery module(s) 59. In some embodiments, the BMS 112 is configured to redistribute charge among the cells, rows/groups, and/or the modules to ensure an equal or substantially equal charge level throughout the energy storage 54. The BMS 112 can communicate with other systems or components or the vehicle 10 or with external devices (e.g., the remote systems 240) to report on battery status and diagnostics and/or to receive control commands.

According to an exemplary embodiment, the BMS 112 is configured to detect faults or failures in the energy storage 54 that may potentially lead to or that have caused an overcharge condition and, thereby, a thermal runaway event. By way of example, the BMS 112 may be configured to monitor the voltage of individual cells, rows/groups, or modules of the energy storage 54, and when deviations from normal voltage levels occur beyond a nominal range, the BMS 112 may determine that a fault or failure is present and that there is a potential for an overcharge condition or that there is an actual overcharge condition. In some implementations, the BMS 112 is configured to detect voltage imbalance or voltage imbalance trends. By way of another example, the BMS 112 may additionally or alternatively be configured to monitor current flows during charging and discharging of the energy storage 54 and identify unexpected fluctuations in current that may indicate that a fault or failure is present and that there is a potential for an overcharge condition or that there is an actual overcharge condition. By way of still another example, the BMS 112 may additionally or alternatively be configured to monitor the temperature of the cells, rows/groups, and/or modules of the energy storage 54 and identify anomalously high temperatures that may indicate that a fault or failure is present and that there is a potential for an overcharge condition or that there is an actual overcharge condition. It should be understood that the above example of detecting faults, failures, or overcharge conditions is provided for example purposes only and is not exhaustive. Other methods or techniques may be implemented to detect faults, failures, or overcharge conditions, which are intended to be included within the scope of the present disclosure. Additional details regarding fault detection regarding the energy storage 54 is described in greater detail herein. Further details regarding fault detection, including voltage imbalance, may be found in U.S. patent application Ser. No. 18/884,363, filed Sep. 13, 2024, which is incorporated herein by reference in its entirety.

### Fleet Monitoring and Control System

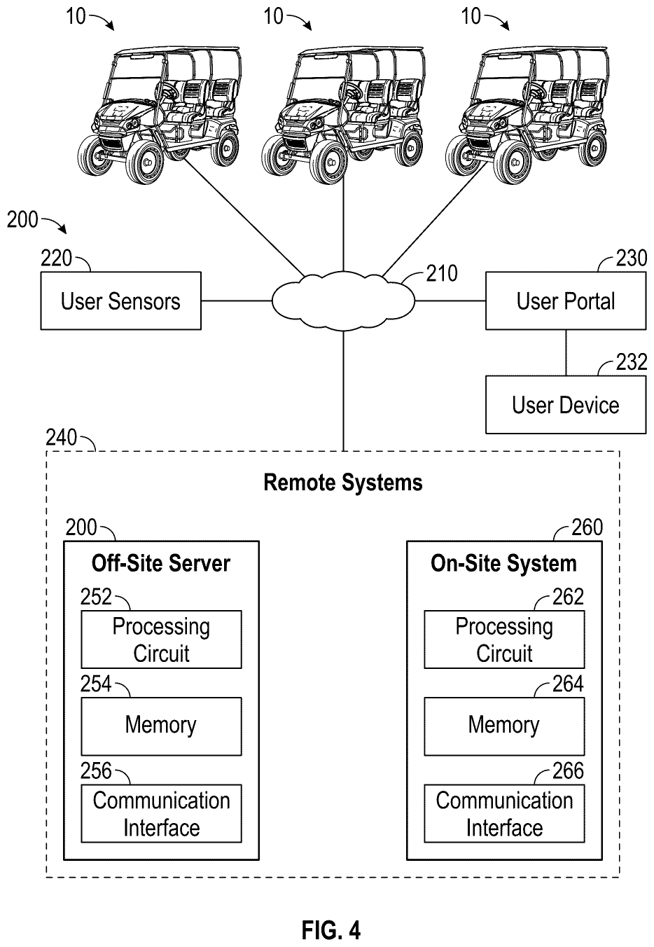

As shown in FIG. 4, a site monitoring and control system, shown as fleet monitoring and control system 200, includes one or more vehicles 10; one or more second sensors, shown as user sensors 220, positioned remote or separate from the vehicles 10; an operator interface, shown as user portal 230, positioned remote or separate from the vehicles 10; an external or remote user device, shown as user device 232, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210. In some embodiments, the fleet monitoring and control system 200 does not includes the user portal 230 and/or the user device 232.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, a heart rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons breaking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). As shown in FIG. 4, the user portal 230 is accessible via the user device 232. The user device 232 may be or include a computer, laptop, smartphone, tablet, or the like. The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 4, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 4, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle control systems 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

In some embodiments, the fleet monitoring and control system 200 and/or components thereof (e.g., the remote systems 240) are configured to communicate and interact with both vehicles 10 that are owned, managed, or otherwise operated by or on behalf of an entity that owns, manages or otherwise operates a site associated with the fleet monitoring and control system 200 (e.g., a fleet of golf carts owned by a golf course associated with the fleet monitoring and control system 200) and vehicles 10 that are owned, managed, or otherwise operated by or on behalf of a third-party entity (e.g., a personally owned golf cart of a golfer playing golf at a golf course). In some instances, the fleet monitoring and control system 200 may be in communication and interact with computing systems (e.g., the remote systems 240) of a plurality of entities associated with multiple different sites (e.g., a plurality of golf clubs associated with a multiple different golf courses). As will be described further below, in some instances, the fleet monitoring and control system 200 may be configured to enable various vehicle modes and corresponding user interfaces to be provided to operators of various vehicles 10 during relevant driving scenarios.

### Personal Use and Golf Vehicle Modes

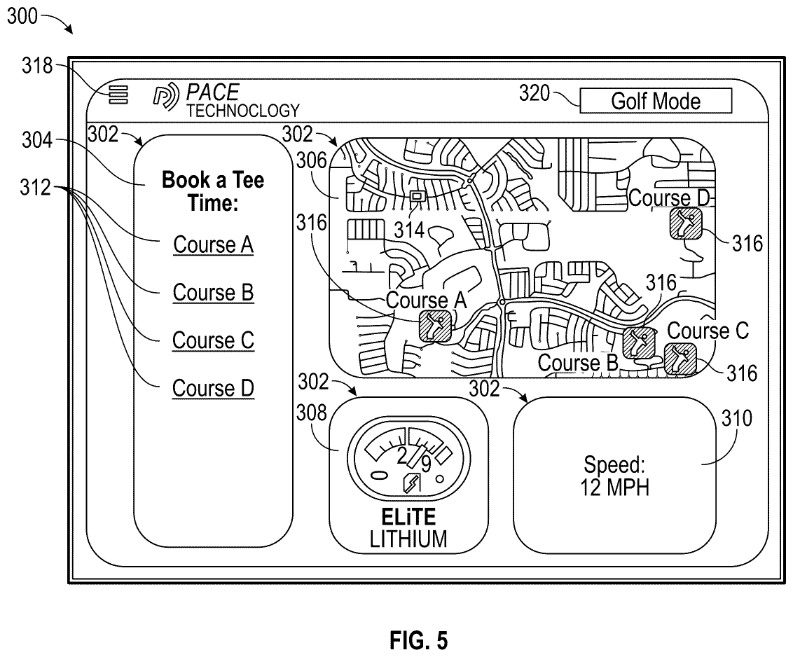

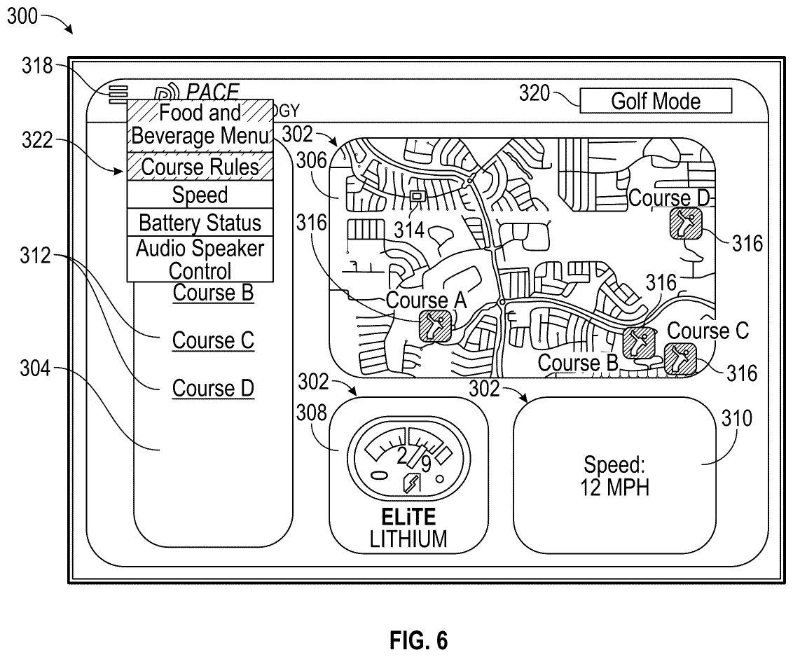

As shown in FIGS. 5-8, various vehicle interfaces may be displayed to an operator of the vehicle 10. In some embodiments, certain vehicle interfaces are displayed to the operator of the vehicle 10 in response to various trigger events (e.g., operator selections, detected vehicle locations, detected scheduled operator tee times or other appointments, etc.). As shown in FIGS. 5 and 6, a first user interface, shown as personal use mode interface 300, includes a plurality of displayed features, shown as widgets 302, installed or otherwise implemented therein. The personal use mode interface 300 may be displayed to an operator via an operator interface (e.g., the operator interface 48) of the vehicle 10 while the vehicle 10 is in a personal use mode.

The personal use mode may enable set of corresponding functionalities associated with the vehicle 10 and/or various remote systems (e.g., the remote systems 240). The personal use mode interface 300 is configured to expose a variety of data and functions enabled within the personal use mode to a vehicle operator. In some embodiments, the personal use mode interface 300 is configured to expose a variety of data and functions and associated with the vehicle systems (e.g., the operator controls 40, the driveline 50, the suspension system 60, the braking system 70, the sensors 90, the vehicle control system 100, etc.) and/or remote systems (e.g., the remote systems 240, third-party networks, other resources and systems accessible via the internet) to the vehicle operator.

As shown in FIG. 5, the widgets 302 of the personal use mode interface 300 include a tee time feature, shown as tee time widget 304; a map feature, shown as map widget 306; a battery indicator feature, shown as battery indicator widget 308; and a speedometer feature, shown as speed widget 310. The tee time widget 304 is configured to allow a user to book a tee time at various golf courses. For example, in some instances, the tee time widget 304 includes a plurality of links 312 to various nearby golf courses with open tee times. Each of the links 312 is selectable via the personal use mode interface 300 and may navigate the user to a corresponding tee time booking webpage or a golf course website associated with the listed golf course within displayed within the tee time widget 304 (e.g., accessed via the communications network 210). Accordingly, an operator of the vehicle 10 may utilize the links 312 to book a tee time at a local golf course using the personal use mode interface 300.

The map widget 306 is configured to display a map of a location of the vehicle 10. In some instances, the map widget 306 includes a vehicle indicator 314 and a plurality of golf course indicators 316. The vehicle indicator 314 is configured to show a location of the vehicle 10 on the map displayed within the map widget 306. For example, in some instances, the personal use mode interface 300 may be configured to obtain a current location of the vehicle 10 from a position or GPS sensor of the vehicle 10 and obtain a map of the location of the vehicle 10 from one or more third-party computing systems configured to provide location services. The various golf course indicators 316 are configured to show the location of various nearby golf courses. As shown in FIG. 5, in some instances, the golf course indicators 316 may corresponding to the various golf courses displayed within the tee time widget 304 that the operator is able to book a tee time at. However, in some embodiments, the courses displayed in the tee time widget 304 may not match or include all of the courses displayed within the map widget 306 or vice versa. In some instances, the operator of the vehicle 10 may additionally create various non-golf-related geofences (e.g., to prevent certain users from driving the vehicle 10 and/or to apply speed or other functional limits to the vehicle 10 in certain areas), and these geofences may similarly be displayed within the map widget 306.

The battery indicator widget 308 is configured to display a real-time graphic indicator an amount of battery life remaining in the battery (e.g., the energy storage 54) of the vehicle 10. For example, in some instances, the personal use mode interface 300 (e.g., the vehicle control system 100 or a separate controller associated with the operator interface 48 generating the personal use mode interface 300) may be configured to obtain a current real-time amount of battery life remaining in the battery via one or more sensors (e.g., the BMS sensor 116) of the vehicle 10. In some embodiments, the real-time graphic indicator includes a gauge-type indicator, as shown in FIG. 5. In other embodiments, the real-time graphic indicator may include another type of indicator, such as a text indicator, a color-based indicator, or any other suitable indicator capable of indicating a remaining amount of battery life. The speed widget 310 is configured to display a real-time speed of the vehicle 10. For example, in some instances, the personal use mode interface 300 (e.g., the vehicle control system 100 or a separate controller associated with the operator interface 48 generating the personal use mode interface 300) may be configured to obtain a current real-time speed of the vehicle 10 via one or more sensors (e.g., the motor sensor 92) of the vehicle 10. In some instances, the real-time speed of the vehicle 10 is displayed as a text indication of the real-time speed, as shown in FIG. 5. In other instances, the real-time speed of the vehicle 10 may be displayed using various other indicators, such as a speedometer or any other suitable indicator capable of indicating a speed of the vehicle 10.

The personal use mode interface 300 may further include a menu icon 318 and a mode switch link 320. As shown in FIG. 6, the operator may click on the menu icon 318 to open a dropdown menu 322 including a variety of selectable options. As will be discussed further below, in some embodiments, the selectable options contained within the dropdown menu 322 may remain the same between different vehicle interfaces displayed to the operator to provide continuity between the vehicle interfaces, thereby improving ease of use between different interfaces with different capabilities. In some embodiments, as shown in FIG. 6, some selectable options may be grayed out or otherwise made unavailable if they are not enabled in a particular vehicle mode corresponding to the displayed user interface.

For example, as shown in FIG. 6, the selectable options include a food and beverage menu option configured to allow the operator to view a food and beverage menu associated with a golf course, a course rules option configured to allow the operator to view various rules (e.g., vehicle rules, pace of play rules, vehicle volume rules, geofences associated with rules, other gameplay or course rules generally) associated with a golf course, a speed option configured to allow the operator to view a current speed of the vehicle 10, a battery status configured to allow the operator to view a current remaining battery life of the battery (e.g., the energy storage 54) of the vehicle 10, and an audio speaker control configured to allow the operator to adjust operation of one or more audio systems of the vehicle 10. In some embodiments, the dropdown menu 322 may include various other options, as desired for a given scenario. As shown in FIG. 6, the food and beverage menu option and the course rules option are both grayed out, as those options are not enabled in the personal use mode. Additionally, as illustrated by FIG. 6, the dropdown menu (e.g., the dropdown menu 322) of each user interface may include options corresponding to features already displayed in within the user interface to ensure the operator can easily find their desired features when switching between different vehicle modes and corresponding user interfaces.

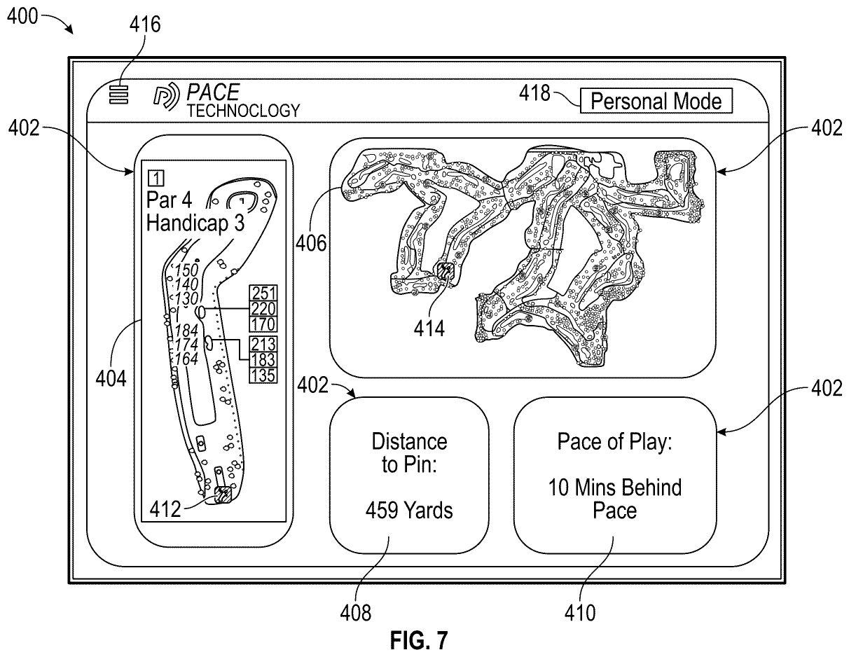

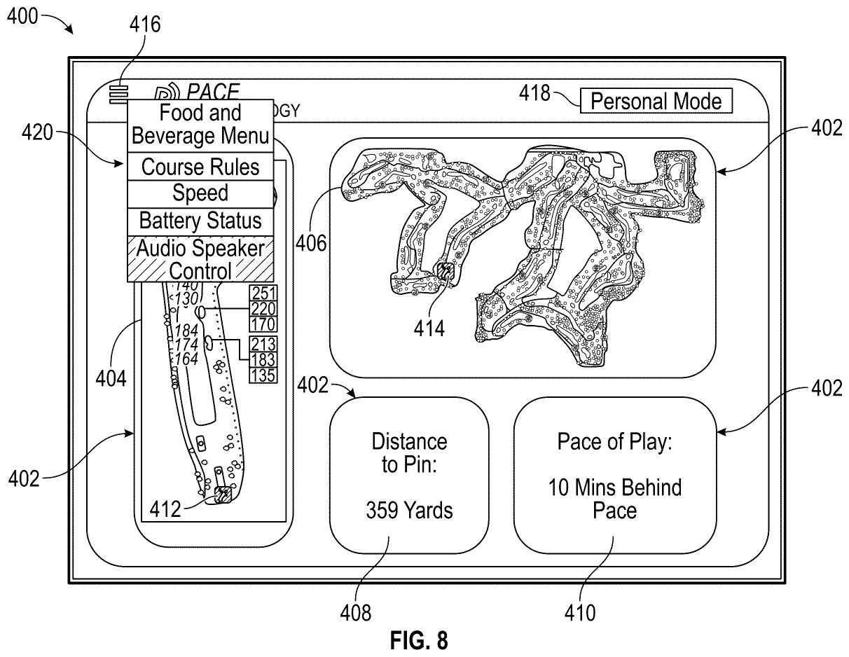

As shown in FIGS. 7 and 8, a second user interface, shown as golf mode interface 400, includes a plurality of displayed features, shown as widgets 402, installed or otherwise implemented therein. The golf mode interface 400 may similarly be displayed to an operator via an operator interface (e.g., the operator interface 48) of the vehicle 10 while the vehicle 10 is in a golf mode.

The golf mode may similarly enable a set of corresponding functionalities associated with the vehicle 10 and/or various remote systems (e.g., the remote systems 240). Further, in some instances, when the vehicle 10 enters the golf mode, the vehicle 10 may begin to share various operational information with a remote system 240 associated with a corresponding golf course (e.g., over the communications network 210). Further, as describe herein, in some instances, when the vehicle 10 is in the golf mode, the remote system 240 associated with the corresponding golf course may be able to control various functionalities of the vehicle 10. However, in some instances, when the vehicle 10 is in or switches back to the personal use mode, the remote system 240 associated with the corresponding golf course (and similarly any other remote systems 240 associated with other golf courses having corresponding golf modes) can no longer track or control the vehicle 10. In some embodiments, various functionalities enabled and/or the various features (e.g., the various widgets 402 and/or options within the dropdown menu 420) displayed within the golf mode may be the same as or similar to various functionalities enabled and/or the various features (e.g., the various widgets 302 and/or options within the dropdown menu 322) within the personal use mode, while various other functionalities enabled and/or features displayed within the golf mode may be different from the various functionalities enabled and/or features displayed within the personal use mode. That is, certain functionalities enabled by the personal use mode may not be enabled within the golf mode, and vice versa.

The golf mode interface 400 is configured to expose a variety of data and functions enabled within the golf mode to a vehicle operator. In some embodiments, the golf mode interface 400 is similarly configured to expose a variety of data and functions and associated with the vehicle systems (e.g., the operator controls 40, the driveline 50, the suspension system 60, the braking system 70, the sensors 90, the vehicle control system 100, etc.) and/or remote systems (e.g., the remote systems 240, third-party networks, other resources and systems accessible via the internet) to the vehicle operator.

As shown in FIG. 7, the widgets 402 of the golf mode interface 400 include a hole map feature, shown as hole map widget 404; a course map feature, shown as course map widget 406; a distance-to-pin feature, shown as distance-to-pin widget 408; and a pace-of-play feature, shown as pace-of-play widget 410. The hole map widget 404 is configured to provide a map graphic of a particular hole the operator of the vehicle 10 is currently playing. In some instances, as will be described further below, upon transitioning into the golf mode, the vehicle 10 may obtain and/or incorporate various information pertaining to a corresponding golf course, including a map of the golf course, into the various widgets 402 of the golf mode interface 400. Accordingly, in some instances, the golf mode interface 400 (e.g., the vehicle control system 100 or a separate controller associated with the operator interface 48 generating the golf mode interface 400) may be configured to obtain a current location of the vehicle 10 from a position or GPS sensor of the vehicle 10 and compare the current location of the vehicle 10 to a location on the map of the golf course to determine which hole the vehicle 10 is currently on (e.g., which hole the operator is currently playing). The golf mode interface 400 may then display a map of the hole (e.g., similarly obtained from one of the remote systems 240) within the hole map widget 404. In some instances, the hole map widget 404 may further include a vehicle indicator 412 configured to show the current location of the vehicle 10 overlaid onto the map of the hole.

The course map widget 406 is configured to provide a map graphic of the entire golf course the operator of the vehicle 10 is currently playing. For example, as discussed above, the vehicle 10 may obtain and/or incorporate various stored information, including the map of the golf course, into the various widgets 402 of the golf mode interface 400. Accordingly, course map widget 406 may incorporate and display a map of the golf course. In some instances, the hole map widget 404 may similarly further include a vehicle indicator 414 configured to show a current location of the vehicle 10 overlaid onto the map of the golf course.

The distance-to-pin widget 408 is configured to display a current distance from the vehicle 10 to the pin on the current hole. For example, as discussed above, the golf mode interface 400 (e.g., the vehicle control system 100 or a separate controller associated with the operator interface 48 generating the golf mode interface 400) may be configured to compare a current location of the vehicle 10 to a map of the current hole on which the vehicle 10 is located to determine the distance from the vehicle 10 to the pin.

The pace-of-play widget 410 is configured to display a current pace of play metric. For example, in some instances, the golf mode interface 400 (e.g., the vehicle control system 100 or a separate controller associated with the operator interface 48 generating the golf mode interface 400) may be configured to obtain a tee time that the operator began their round of golf (e.g., from one of the remote systems 240 associated with the golf course). The golf mode interface (e.g., the vehicle control system 100 or a separate controller associated with the operator interface 48 generating the golf mode interface 400) may then be configured to compare a current location of the vehicle 10 to an expected location of the vehicle 10 determined based on an appropriate pace of play for the golf course. For example, in some instances, the expected pace of play may be estimated based on a speed at which other vehicles on the golf course are moving through their respective rounds of golf. In some other instances, the expected pace of play may be set by a user of one of the remote systems 240 associated with the golf course (e.g., 10 minutes per hole).

The golf mode interface 400 may similarly further include a menu icon 416 and a mode switch link 418. As shown in FIG. 8, the operator may click on the menu icon 416 to open a dropdown menu 420 including a variety of selectable options. As mentioned above, in some embodiments, the selectable options contained within the dropdown menu 420 may remain the same between different vehicle interfaces (e.g., the dropdown menu 322 and the dropdown menu 420 include the same selectable options) displayed to the operator to provide continuity between the vehicle interfaces, thereby improving ease of use between different interfaces with different capabilities. In some embodiments, as shown in FIG. 8, some selectable options of the dropdown menu 420 may similarly be grayed out or otherwise made unavailable if they are not enabled in a particular vehicle mode corresponding to the displayed user interface.

For example, as shown in FIG. 8, the selectable options of the dropdown menu 420 similarly include a food and beverage menu option configured to allow the operator to view a food and beverage menu offered by the golf course, a course rules option configured to allow the operator to view various rules (e.g., vehicle rules, pace of play rules, other gameplay or course rules generally) associated with the golf course, a speed option configured to allow the operator to view a current speed of the vehicle 10, a battery status configured to allow the operator to view a current remaining battery life of the battery (e.g., the energy storage 54) of the vehicle 10, and an audio speaker control configured to allow the operator to adjust operation of one or more audio systems of the vehicle 10. In some embodiments, the dropdown menu 420 may similarly include various other options, as desired for a given scenario. As shown in FIG. 8, audio speaker control option is grayed out. In this example shown in FIG. 8, the audio speaker control option may be disabled based on golf course rules set by the golf course and communicated from a remote system 240 to the vehicle 10 (e.g., upon entering the golf mode). In some instances, certain options may similarly be grayed out if they correspond to services not offered by a given golf course. For example, if a golf course does not offer food or beverages to be ordered via the golf mode interface, that option may similarly be grayed out.

It should be appreciated that, in some instances, the personal use mode interface 300 and/or the golf mode interface 400 described above, as well as their respective functionalities and uses described herein (e.g., the method 600 and the method 700 described below), may be generated and/or otherwise provided by the vehicle control system 100 via the processing circuit 102 executing instructions stored within the memory 104 and utilizing the communications interface 106 (e.g., to communicate with and obtain various information from various remote systems 240). In some other instances, the personal use mode interface 300 and/or the golf mode interface 400 described above, as well as their respective functionalities and uses described herein (e.g., the method 600 and the method 700 described below), may be generated and/or otherwise provided by a separately provided and later-installed operator interface (e.g., the operator interface 48) that is installed within, electronically and communicatively coupled to, and mounted on the vehicle 10.

For example, in some instances, the operator interface 48 may be sold separately from the vehicle 10 and later installed on, electronically and communicatively coupled to, and mounted on the vehicle 10, and may access the various functionalities described herein via an application provided by and/or communications with (e.g., via the communications network 210) one of the remote systems 240 associated with a manufacturer or provider of the fleet monitoring and control system 200. In these instances, the operator interface (e.g., the operator interface 48) may similarly include a processing circuit, a memory, and a communications interface similar to the processing circuit 102, the memory 104, and the communications interface 106 of the vehicle control system 100, such that similar instructions stored on the memory of the operator interface can be executed by the processing circuit of the operator interface to generate and/or otherwise provide the personal use mode interface 300 and/or the golf mode interface 400 described above, as well as their respective functionalities described herein.

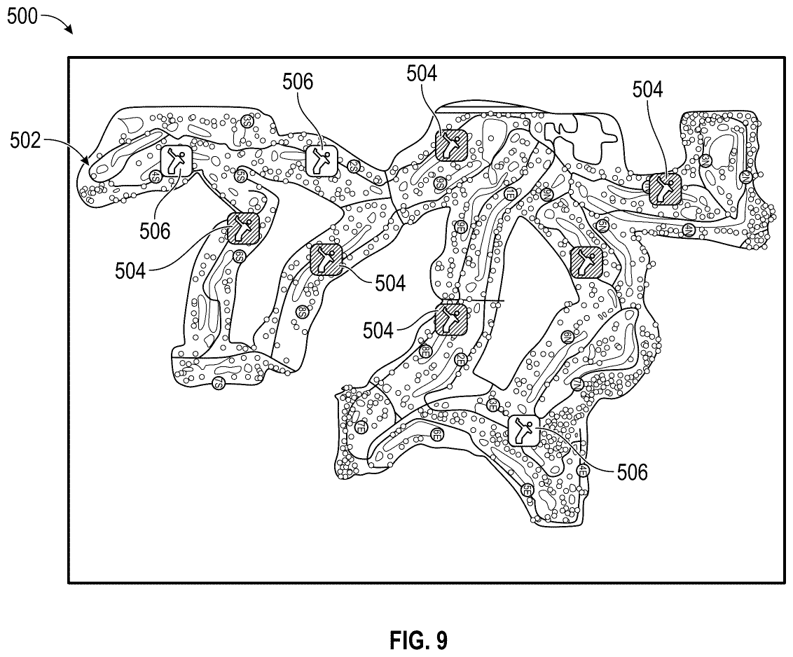

As shown in FIG. 9, a third user interface, shown as golf course management user interface 500, includes a map 502 of the golf course, a plurality of golf course vehicle indicators 504, and a plurality of personal vehicle indicators 506. The golf course management user interface 500 may be displayed to a user of a remote system 240 associated with the golf course. The plurality of golf course vehicle indicators 504 correspond to a plurality of golf course vehicles (e.g., similar to the vehicle 10) that are owned, managed, and/or otherwise operated by the golf course. Accordingly, the remote system 240 associated with the golf course may pull real-time location information from each of the golf course vehicles and overlay the real-time locations of the golf course vehicles onto the map 502 as corresponding golf course vehicle indicators 504 to allow for a user of the remote system 240 to view where all of the golf course vehicles are located on the golf course (e.g., via a display of the remote system 240).

The plurality of personal vehicle indicators 506 correspond to a plurality of personal vehicles (e.g., similar to the vehicle 10) that are owned, managed, and/or otherwise operated by players or patrons of the golf course. In some instances, upon transitioning into the golf mode, each personal vehicle 10 may prompt the operator (e.g., via the operator interface 48) to accept various terms of using a personal vehicle on the golf course. Accordingly, upon accepting those terms and switching from the personal use mode into the golf mode, each personal vehicle (e.g., the vehicle control system 100) may similarly begin to share various operational information (e.g., a real-time location of the personal vehicle, a speed of the personal vehicle, other relevant operational information) with (e.g., transmit the operational information periodically or continuously to) the remote system 240 associated with the golf course to allow for the remote system 240 associated with the golf course to track each personal vehicle 10 and its operations. In some instances, the remote system 240 associated with the golf course may further be able to control or limit various functionalities of the vehicle 10 while the vehicle 10 is in the golf mode on the golf course.

Accordingly, the remote system 240 associated with the golf course may similarly pull real-time location information from each of the personal vehicles and overlay the real-time locations of the personal vehicles onto the map 502 as corresponding personal vehicle indicators 506 to allow for a user of the remote system 240 to similarly view where all of the personal vehicles are located on the golf course (e.g., via a display of the remote system 240). In some instances, an operator of a personal vehicle can request that their location not be monitored and, upon approval by an authorized user of the remote system 240 of the golf course, this request can be granted, such that the location of the personal vehicle is not tracked and no corresponding personal vehicle indicator 506 is displayed on the map 502.

As shown in FIG. 9, in some instances, the personal vehicle indicators 506 may be shown differently from the golf course vehicle indicators 504. For example, in some instances, the personal vehicle indicators 506 may be a different color, shape, or symbol than the golf course vehicle indicators 504, or may include some other suitable indicia for differentiating between the personal vehicle indicators 506 and the golf course vehicle indicators 504, to allow for the user of the remote system 240 associated with the golf course to determine which vehicles shown on the map 502 are personal vehicles and which are golf course vehicles.

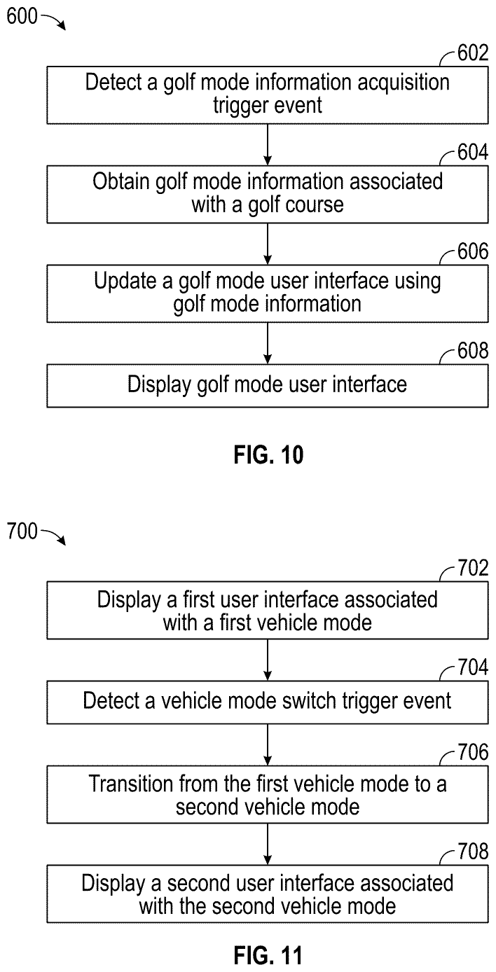

As shown in FIG. 10, a method 600 for acquiring golf mode information includes detecting a golf mode information acquisition trigger event, obtaining golf mode information associated with a golf course, updating a golf mode interface using the golf mode information, and displaying a golf mode interface. For clarity, the following description is provided in reference to the vehicle control system 100 performing the method 600. However, it should be appreciated that one or more of the same or similar steps may be performed (e.g., in combination with the vehicle control system 100 or remotely from the vehicle control system 100) by one of the remote systems 240 (e.g., an off-site server 250) and/or a separately provided and later-installed operator interface (e.g., the operator interface 48) that is installed within, electronically and communicatively coupled to, and mounted on the vehicle 10 to perform the method 600.

The method 600 begins with detecting a golf mode information acquisition trigger event, at step 602. The golf mode information acquisition trigger event may be a detected event that triggers the vehicle control system 100 to pull or download golf mode information from a golf course to enable the vehicle control system 100 to incorporate golf-course specific information for the golf course into a golf mode interface (e.g., the golf mode interface 400).

In some instances, the detected information acquisition trigger event may include detecting that the operator has booked a tee time at the golf course. In some instances, the vehicle control system 100 may detect the booked tee time by receiving a notification from a remote system 240 associated with the golf course when the operator books a tee time at the golf course. For example, in some instances, the operator may utilize the user device 232 or the personal use mode interface 300 to book a tee time with the golf course via a website or application hosted or otherwise provided by the golf course via the remote system 240, and the website or application may prompt the operator to ask if they will be using a personal vehicle while golfing. If the operator indicates they will be using a personal vehicle, the operator may provide a serial number associated with the vehicle 10 (e.g., a serial number associated with the vehicle control system 100 and/or the operator interface 48) or, if the operator books the tee time via the operator interface 48, the serial number may be automatically transmitted to the remote system 240. The remote system 240 may then utilize the serial number to identify the vehicle 10 and push the notification indicating that the operator has booked a tee time to the vehicle 10 (e.g., via the communications network 210). Similarly, in some instances, the operator may be a member of a golf club at the golf course and may have earlier provided a serial number for their personal golf cart. Accordingly, when the operator books their tee time, they may provide a member number to the remote system 240 associated with the golf course. The remote system 240 may then determine that the operator has booked a tee time and that the member number provided corresponds to a personal vehicle serial number (or a serial number associated with the operator interface 48) associated with a personal vehicle. Accordingly, the remote system 240 may automatically send a notification indicating that the operator has booked a tee time to the vehicle 10 (e.g., via the communications network 210).

In some instances, the detected information acquisition trigger event may include receiving a user selection of the golf course via the operator interface. For example, the operator may be able to select a course via the personal use mode interface 300 (e.g., by clicking on one of the golf course indicators 316 on the map widget 306 or by clicking one of the links 312 of the tee time widget 304) and select to download the golf mode information associated with the golf course.

In some instances, the detected information acquisition trigger event may include determining that the vehicle 10 has arrived at the golf course. For example, in some instances, the vehicle control system 100 may be configured to monitor a location of the vehicle (e.g., via a GPS or position sensor of the vehicle 10) and detect when the vehicle 10 has arrived at the golf course by comparing a location of the vehicle 10 to a location of the golf course. In some instances, the vehicle control system 100 may determine that the vehicle 10 has arrived at the golf course by detecting that a location of the vehicle 10 has entered a geofenced area associated with and set by the golf course. In some instances, the vehicle control system 100 may determine that the vehicle 10 has arrived at the golf course by detecting that both a location of the vehicle 10 has entered a geofenced area associated with and set by the golf course and the vehicle 10 has remained within the geofenced area for a predetermined amount of time (e.g., 10 minutes, 20 minutes, an hour, etc.).

Upon detecting the golf mode information acquisition trigger event, at step 602, golf mode information associated with the golf course is then obtained, at step 604. For example, a remote system 240 associated the golf course may provide the vehicle control system 100 with a variety of information pertaining to the golf course and for use in generating the golf mode interface 400. In some instances, the remote system 240 may push or transmit the golf mode information to the vehicle control system 100. In some instances, the vehicle control system 100 may pull, request, or otherwise obtain the golf mode information from the remote system 240.

In some instances, the golf mode information includes a map of the golf course, various rules associated with the golf course (e.g., speed limits, pace of play rules, other geofence-based rules, etc.), advertising the golf course wishes to display to the operator, and/or information pertaining to various services provided by the golf course (e.g., a food and beverage menu). For example, the remote system 240 associated with the golf course may apply various rules to vehicles while the vehicles are operating at the golf course. In some instances, the remote system 240 may apply different rules to different groups of vehicles. For example, the golf course may set and apply different rules to golf course vehicles (e.g., vehicles owned by the golf course) and personal vehicles (e.g., personally owned vehicles brought onto the golf course by players), as well as for different groups (e.g., golfing groups, spectator groups, disability groups, VIP groups, etc.).

In some instances, the vehicle control system 100 and/or the remote system 240 associated with the golf course are able to determine whether the vehicle 10 is a personal vehicle or a golf course vehicle, as well as which group the vehicle belongs to, such that the proper golf mode information is provided to the vehicle control system 100. For example, the vehicle control system 100 and/or the remote system 240 may determine whether the vehicle 10 is a personal vehicle or a golf course vehicle using various credentials associated with the golf course (e.g., the golf course vehicles may be programmed with a passcode indicating that they are owned by the golf course, whereas the personal vehicles will not have this passcode). Similarly the vehicle control system 100 and/or the remote system 240 may determine a vehicle group for the vehicle 10 based on information gathered from the operator when the operator books their tee time.

In some instances, the rules applied to personal vehicles may include, for example, various speed or other operational rules (e.g., the remote system 240 may limit a speed of the vehicle 10 on the golf course or within predefined geofenced areas). For example, upon accepting the terms of using a personal vehicle at the golf course and entering the golf mode, the operator may provide authorization for the remote system 240 to control and/or disable one or more functionalities associated with the vehicle 10 while the vehicle 10 is in golf mode. As an example, in accordance with rules set for personal vehicles at the golf course (e.g., set by a user of the remote system 240), the remote system 240 associated with the golf course may limit a top speed of the vehicle on the golf course or within predefined geofenced areas on the golf course. In some instances, the rules may cause the remote system 240 to take control of the motor function of the vehicle 10 if the vehicle 10 has entered a restricted or other geofenced area on the golf course (e.g., the remote system 240 may remotely control the vehicle 10 to only allow the vehicle 10 to travel out of the restricted area). For example, the golf course may set particular driving rules, such as a cart path only rule (e.g., vehicles may only be driven on cart pats), an out of bounds rule (e.g., vehicles may not drive in certain out of bounds areas), and/or various other driving rules that may each be associated with or tied to a corresponding geofence set by a user of the remote system 240 associated with the golf course. In some instances, the rules may include a vehicle volume rule that additionally cause the remote system 240 to disable or lower a volume of any private audio systems connected to the vehicle 10 (e.g., to prevent loud noise on the golf course or within certain geofenced areas). It should be appreciated that the rules discussed herein are provided as examples, and various other rules may be set, as appropriate, by various golf courses.

After obtaining the golf mode information associated with the golf course, at step 604, a golf mode interface is updated using the golf mode information, at step 606. In some instances, the vehicle control system 100 is configured to incorporate the various golf mode information into the golf mode interface 400 discussed above. For example, in some instances, the vehicle control system 100 may incorporate appropriate hole maps into the hole map widget 404 and a map of the golf course into the course map widget 406. The vehicle control system 100 may further utilize a map of the golf course included in the golf mode information to track the distance from the vehicle 10 to the pin, which may be displayed within the distance-to-pin widget 408, as well as to track the operator's pace of play, which may similarly be displayed within the pace-of-play widget 410.

In some instances, the golf mode information may be stored by the vehicle control system 100 (e.g., within the memory 104) after it is obtained. In some instances, the vehicle control system 100 may obtain golf mode information for a plurality of golf courses (e.g., based on a plurality of similar corresponding trigger events to those discussed above) and store the golf mode information for each individual golf course within the memory 104. Accordingly, upon transitioning from the personal use mode to the golf mode, the vehicle control system 100 may determine which golf course the vehicle 10 is being used at (as will be described in further detail below, with respect to the method 700) and utilize stored golf mode information corresponding to that golf course to update the golf mode interface 400. In some instances, the vehicle control system 100 may update and store a plurality of golf mode interfaces (e.g., similar to the golf mode interface 400), where each golf mode interface corresponds to and integrates golf mode information pertaining to a corresponding golf course into its features (e.g., the widgets 402 and/or the options included in the dropdown menu 420).

In some instances, each golf mode interface of the plurality of golf mode interfaces may be arranged similarly, such that certain features (e.g., the widgets 402) having similar functionality are displayed in the same location on each golf mode interface. For example, in the example golf mode interface 400, the hole map widget 404 is located on the left hand side of the golf mode interface 400, and the course map widget 406 is located in the upper righthand corner of the golf mode interface 400. Accordingly, in some instances, each golf mode interface of the plurality of golf mode interfaces may similarly include a hole map widget 404 on the left hand side of the golf mode interface 400 and a course map widget 406 on the upper righthand corner of the golf mode interface 400, but the individual map widgets may incorporate different maps for each golf course (i.e., maps of the specific golf course corresponding to the associated golf mode interface). It will be appreciated that that layout of the golf mode interface 400 shown in FIG. 7, as well as that of the personal use mode interface 300 shown in FIG. 5, are provided as examples and are not meant to be limiting.

Additionally, in some instances, the operator may be able to select where certain widget types are to be located within the various user interfaces. For example, the operator may provide an indication to the vehicle control system 100 via the operator interface 48 that they want the course map widget 406 for each golf mode interface to be located in a different location than that shown in FIG. 7 (e.g., in the lower lefthand corner), and these preferences may be implemented into each of the various golf mode interfaces. Accordingly, in some instances, the remote systems 240 associated with the various golf courses may be granted various capabilities (e.g., being able to apply golf-course specific vehicle rules to vehicles on their golf courses), while still allowing for operators to retain various user interface and vehicle preferences. The operator may similarly provide these kinds of preferences with respect to the locations of the widgets 302 of the personal use mode interface 300.

In some instances, the vehicle control system 100 may be configured to only store golf mode information for a predetermined number of golf courses (e.g., ten golf courses). Accordingly, in some instances, once the predetermined number of golf courses have been downloaded and stored, if additional golf mode information pertaining to a new golf course needs to be downloaded, the vehicle control system 100 may be configured to delete previously stored golf mode information associated with one or more golf courses.

In some instances, the vehicle control system 100 may be configured to prompt the user to select the golf course for which they wish to have the associated golf mode information deleted. In some instances, the vehicle control system 100 may be configured to automatically delete golf mode information for one or more golf courses based on one or more prioritization criteria. For example, in some instances, the prioritization criteria may specify that the golf mode information is to be deleted based on a frequency of play associated with each golf course (e.g., the least-played golf course has its golf mode information deleted first), a recency of play of each golf course (e.g., the least recently played golf course has its golf mode information deleted first), a proximity of each golf course (e.g., the farthest golf course from a stored home location of the operator has its golf mode information deleted first), or any other suitable prioritization criteria. Accordingly, in some instances, the vehicle control system 100 may be configured to obtain and store various golf course history information (e.g., which golf courses the operator played, when they played those golf courses, where those golf courses are located, etc.) to allow for the vehicle control system 100 to apply the proper prioritization criteria when deleting various golf mode information. In some instances, the operator may be allowed to select (e.g., via the operator interface 48) the prioritization criteria they would like to have applied to the golf mode information for the various golf courses.

In some instances, the various golf mode information may be obtained piecewise in response to a series of trigger events. For example, in some instances, an initial trigger event (e.g., similar to the various golf mode information acquisition trigger events discussed above) may trigger the acquisition of a first set of initial golf mode information for a golf course, and a secondary trigger event (e.g., similar to the various golf mode information acquisition trigger events discussed above) may trigger the acquisition of a second set of additional golf mode information for the golf course.

As an example, in some instances, it may be beneficial to download a first set of unchanging (or less frequently changing) golf mode information (e.g., golf course maps, golf course rules) in advance of (e.g., the night before) the operator showing up to play a golf round to reduce the amount of time the operator has to spend downloading golf mode information upon their arrival at the golf course. Accordingly, this first set of golf mode information may be downloaded onto the vehicle control system 100 upon detection of an initial trigger event (e.g., the operator booking a tee time at the golf course). However, some information (e.g., current services offered, temporary golf course rules, food and beverage menus, etc.) may change periodically (e.g., daily, weekly, monthly). Accordingly, it may be beneficial to allow for this information to be downloaded upon the arrival of the vehicle 10 at the golf course. Accordingly, this second set of golf mode information may be downloaded onto the vehicle control system 100 upon detection of a secondary trigger event (e.g., the vehicle control system 100 detecting that the vehicle 10 has entered a geofence associated with the golf course, the vehicle control system 100 determining that the operator's tee time has arrived).

Similarly, in some instances, if a vehicle 10 shows up to a golf course and has not yet downloaded any of the golf mode information, it may be beneficial to download the golf mode information in smaller batches to allow for the operator to begin their round of golf more quickly. For example, upon arriving at the golf course, the vehicle control system 100 may detect that the vehicle 10 has entered the geofence associated with the golf course, which may trigger an initial golf mode information acquisition pertaining to a first golf hole (or a first subset of golf holes). Accordingly, the golf mode interface 400 may be initially updated with the information pertaining to the first golf hole. Then, the vehicle control system 100 may determine that the vehicle 10 has entered a second geofenced area with a tee box of the first hole on the golf course and, responsive to this determination, the vehicle control system 100 may then download information pertaining to a second golf hole and implement that information into the golf mode interface 400 once the vehicle 10 reaches the second hole. By downloading the information in this hole-by-hole manner, the operator may more quickly download the information they need for the golf mode interface 400 to be updated for each hole without having to wait for all of the information associated with the golf course to be downloaded at once prior to starting their round.

Accordingly, after obtaining the golf mode information associated with the golf course, at step 604, and updating the golf mode interface using the appropriate golf mode information, at step 606, the golf mode interface is displayed, at step 608. For example, the golf mode interface 400 may be displayed to the operator of the vehicle 10 via the operator interface 48.

As shown in FIG. 11, a method 700 for switching between a personal use mode and a golf mode includes displaying a first user interface associated with a first vehicle mode, detecting a vehicle mode switch trigger event, transitioning from the first vehicle mode to a second vehicle mode, and displaying a second user interface associated with the second vehicle mode. For clarity, the following description is provided in reference to the vehicle control system 100 performing the method 700. However, it should be appreciated that one or more of the same or similar steps may be performed (e.g., in combination with the vehicle control system 100 or remotely from the vehicle control system 100) by one of the remote systems 240 (e.g., an off-site server 250) and/or a separately provided and later-installed operator interface (e.g., the operator interface 48) that is installed within, electronically and communicatively coupled to, and mounted on the vehicle 10 to perform the method 700.

The method 700 begins with displaying a first user interface associated with a first vehicle mode, at step 702. For example, the first vehicle mode may be the personal use mode described above. Accordingly, while the vehicle 10 is in the personal use mode, the operator interface 48 may display the personal use mode interface 300 discussed above. In the personal use mode, the vehicle 10 may not be subject to any external control (e.g., from the remote system 240) or rules promulgated by any golf courses. For example, the vehicle 10 may not have any speed limit applied to it apart from any original equipment manufacturer limits and may utilize any and all of its normal functionality.

After displaying a first user interface associated with a first vehicle mode, at step 702, a vehicle mode switch trigger event is detected, at step 704, and the vehicle 10 is transitioned from the first vehicle mode to a second vehicle mode, at step 706. For example, the second vehicle mode may be the golf mode described above. The vehicle mode switch trigger event may include a variety of similar triggers to the golf mode information acquisition trigger events discussed above. Accordingly, the vehicle mode switch trigger event may be detected in similar ways to those discussed above, with respect to the golf mode information acquisition trigger events.

For example, in some instances, the vehicle mode switch trigger event may include the vehicle control system 100 receiving an indication from the operator (e.g., via the mode switch link 320) that the operator wishes to transition into the golf mode. In some other instances, the vehicle mode switch trigger event may include the vehicle control system 100 detecting that the vehicle has arrived at the golf course (e.g., the vehicle 10 has entered the geofenced area associated with the golf course). In some instances, the vehicle mode switch trigger event may include the vehicle control system 100 has remained within the geofenced area associated with the golf course for a predetermined period of time (e.g., 10 minutes, 20 minutes, an hour, etc.). In some instances, the vehicle mode switch trigger event may include the vehicle control system 100 determining that a tee time scheduled by the operator at the golf course has arrived (e.g., the tee time matches a current time).

In some instances, upon detecting the vehicle mode switch trigger event, the vehicle control system 100 may prompt the user or operator of the vehicle 10 (e.g., via the operator interface 48) asking the user or operator to confirm whether they are using their personal vehicle and/or whether they wish to transition from the first vehicle mode to the second vehicle mode. Accordingly, if the user or operator is using their personal vehicle and wishes to transition into the golf mode, the user or operator can provide a positive indication to the vehicle control system 100 (e.g., via the operator interface), and the vehicle control system 100 can transition the vehicle 10 from the first vehicle mode (e.g., the personal use mode) to the second vehicle mode (e.g., the golf mode) in response to receiving the positive indication.

Alternatively, if the user or operator provides a negative indication in response to the prompt asking whether they wish to transition from the first vehicle mode to the second vehicle mode, the vehicle control system 100 may maintain the vehicle 10 in the first vehicle mode. However, in some instances, the vehicle control system 100 and/or the remote system 240 associated with the golf course may be configured to override the user's negative indication if it is detected that the operator of the vehicle 10 is likely playing golf on the golf course. For example, in some instances, the vehicle control system 100 may be configured to detect an override trigger event associated with the golf course that causes the vehicle control system 100 to override the operator's negative indication and force the vehicle 10 into the second vehicle mode (e.g., the golf mode). In some instances, if the operator declines to switch into the golf mode and it appears that the operator of the vehicle 10 is playing golf, the vehicle control system 100 may generate and transmit a notification to the remote system 240 associated with the golf course to make the golf course staff aware.

In some instances, the override trigger event may include detecting that the vehicle 10 has remained within the geofenced area associated with the golf course and has performed a series of movements indicative of playing a round of golf. For example, if the vehicle control system 100 determines that the vehicle 10 has traveled through multiple golf holes in sequence (e.g., the vehicle 10 has traveled to the first tee box, the first green, the second tee box, the second green, etc.), the vehicle control system 100 may automatically transition from the personal use mode to the golf mode. In some times, the override trigger event may include both detecting the series of movements and determining that the series of movements match an expected timeframe for those movements if the operator were playing a round of golf. For example, if the vehicle 10 drives straight from the first tee box, past the first green, past the second tee box, past the second green, and then stops at the third tee box, the sequence of movements may be indicative of the operator playing a round of golf, but the timeframe would not match an expected timeframe. That is, driving straight through the various holes may take a significantly shorter amount of time as compared to playing each hole as the vehicle 10 is driven through the holes. Accordingly, the vehicle control system 100 may be configured to determine an expected golfing pace (e.g., based on pace of play information obtained from the remote system 240 associated with the golf course) and only transition from the personal use mode to the golf mode if the vehicle 10 is both traveling holes sequentially and is doing so at or near the expected golfing pace. In some instances, the expected pace of play may corresponding to a proportion of time spent at various locations. For example, if the user is travelling sequentially through the holes and is spending a predefined proportion of their time (e.g., a third of their time) between the tee box and the green on each hole, this may be indicative that they are playing a round of golf and may trigger the forced transition from the personal use mode into the golf mode.

In some instances, instead of the vehicle control system 100 overriding the operator's negative indication, the remote system 240 associated with the golf course may remotely force the vehicle 10 to transition from the personal use mode to the golf mode. For example, in some instances, to download the golf mode information, as discussed above with respect to the method 600, the user or operator may authorize the remote system 240 to track a location of the vehicle 10 while the vehicle 10 located within the geofenced area associated with the golf course regardless of whether the vehicle 10 is in the personal use mode or the golf mode. Accordingly, the remote system 240 may similarly determine that the vehicle 10 is traveling sequentially through the holes of the golf course and/or that the vehicle 10 is traveling sequentially through the holes at an expected golfing pace, as discussed above with respect to the vehicle control system 100, and, responsive to this determination, force the vehicle 10 to transition from the personal use mode to the golf mode. In some instances, if the operator declines to switch into golf mode, the remote system 240 may be authorized and configured to shut the vehicle 10 down, disable various functions of the vehicle 10, and/or initiate an alert sound on the vehicle 10 until the vehicle 10 switches into golf mode or leaves the geofenced area associated with the golf course. Additionally, in some instances, if the operator declines to switch into the golf mode and the remote system 240 associated with the golf course determines that the operator of the vehicle 10 is playing golf, the remote system 240 may generate and display a notification to a user of the remote system 240 to make the golf course staff aware of the vehicle 10 and its status.

In some instances, upon transitioning into the golf mode, the vehicle control system 100 may transmit a notification to the remote system 240 associated with the golf course indicating that the vehicle 10 is transitioning into the golf mode and that the operator is about to play a round of golf. In some instances, the remote system 240 may be able to accept or deny the transition. For example, if the operator is not scheduled to play a round of golf and does not have a tee time (or if the operator has been banned or suspended from playing at the golf course), the remote system 240 may automatically or in response to a user input deny the transition into the golf mode. Alternatively, the remote system 240 and/or a user of the remote system 240 may approve the transition into the golf mode.

Once the transition is approved and takes place, the remote system 240 may then monitor and track the movements of the vehicle 10 (e.g., via a corresponding personal vehicle indicator 506 on the golf course management user interface 500) to ensure that the vehicle 10 is following various course rules (e.g., speed limit rules, pace-of-play rules, vehicle volume rules, cart path rules, etc.). Additionally, in some instances, the notification that the vehicle 10 is in the golf mode may additionally initiate a two-way communication channel between the vehicle 10 and the remote system 240 associated with the golf course such that a user of the remote system 240 can communicate with the operator of the vehicle 10 (e.g., via various audio and/or visual communication methods provided via the operator interface 48 and a similar operator interface of the remote system 240) while the operator is playing their round of golf.

After transitioning from the first vehicle mode to the second vehicle mode, at step 706, a second user interface associated with the second vehicle mode is displayed, at step 708. For example, the second user interface may be the golf mode interface 400 discussed above and may be displayed to the operator via the operator interface 48.

In some instances, there may similarly be various trigger events for switching back from the golf mode into the personal use mode. In some instances, the trigger events for switching back to the personal use mode may be similar to those discussed above. For example, in some instances, a trigger event for switching from the golf mode to the personal use mode may include the vehicle control system 100 detecting that the vehicle 10 has exited the geofenced area associated with the golf course and/or determining that the vehicle 10 has remained outside of the geofenced area associated with the golf course for a predetermined amount of time (e.g., ten minutes, twenty minutes, an hour, etc.). In some instances, a trigger event for switching from the golf mode to the personal use mode may include the vehicle control system 100 receiving an indication from the operator (e.g., via the mode switch link 418) that the operator wishes to return to the personal use mode. In some instances, a trigger event for switching from the golf mode to the personal use mode may include the vehicle control system 100 (or the remote system 240 associated with the golf course) detecting that the vehicle 10 is not moving in a way that is indicative of playing a round of golf. For example, the vehicle control system 100 (or the remote system 240) may determine that the vehicle 10 has traveled to various holes out of order or at a pace that is not indicative of a golfing pace of play, and this may be detected as a trigger event for switching out of the golf mode and into the personal use mode.

Accordingly, upon detecting any of these trigger events, the vehicle control system 100 may transition the vehicle 10 back into the personal use mode and again display the personal use mode interface 300. In some instances, if the trigger event for switching from the golf mode back to the personal use mode was not an indication from the operator of the vehicle 10, the vehicle control system 100 (or the remote system 240) may similarly prompt the operator of the vehicle 10 to confirm whether they wish to leave the golf mode and return to the personal use mode. Accordingly, the operator may provide a positive or negative indication (e.g., via the operator interface 48) to transition back to the personal use mode or to stay within the golf mode. In some instances, upon transitioning back to the personal use mode, the vehicle control system 100 may stop sharing the location of the vehicle 10 with the remote system 240, such that the corresponding personal vehicle indicator 506 is removed from and is no longer visible on the golf course management user interface 500.

As utilized herein with respect to numerical ranges, the terms “approximately,” “about,”“substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.), the fleet monitoring and control system 200 (e.g., the remote systems 240, the user portal 230, the user sensors 220, etc.), the personal use mode interface 300, and the golf mode interface 400, as shown in the various exemplary embodiments, is illustrative only. Additionally, to the extent possible, any element disclosed in one embodiment may be incorporated or utilized with any other embodiment disclosed herein.

1. A vehicle system comprising:
at least one processing circuit having at least one processor and at least one memory having instructions stored thereon that, when executed by the at least one processor, cause the at least one processor to:
detect a trigger event associated with a golf course while a personal vehicle of a user is in a first vehicle mode; and
transition the personal vehicle from the first vehicle mode to a second vehicle mode associated with the golf course based on detecting the trigger event;
wherein the personal vehicle has a first set of functionalities while in the first vehicle mode and a second set of functionalities while in the second vehicle mode, the second set of functionalities being different than the first set of functionalities and corresponding to at least one rule associated with the golf course.

2. The vehicle system of claim 1, wherein the at least one rule is a geofence-based rule associated with at least a portion of the golf course and includes one or more of a speed limit rule, a vehicle volume rule, an out-of-bounds rule, or a cart path rule.

3. The vehicle system of claim 1, wherein, in the second vehicle mode, the personal vehicle continuously or periodically transmits operational information to a golf course computing system associated with the golf course to enable tracking of the personal vehicle.

4. The vehicle system of claim 1, wherein detecting the trigger event associated with the golf course comprises at least one of detecting that the personal vehicle has entered a geofenced area associated with the golf course or determining that a current time matches a tee time scheduled by the user associated with the personal vehicle.

5. The vehicle system of claim 4, wherein the trigger event is a second vehicle mode trigger event, and the instructions further cause the at least one processor to:
detect a first vehicle mode trigger event; and
transition from the second vehicle mode to the first vehicle mode based on detecting the first vehicle mode trigger event.

6. The vehicle system of claim 5, wherein detecting the first vehicle mode trigger event comprises at least one of detecting that the personal vehicle has exited the geofenced area associated with the golf course or receiving an indication from the user to switch from the second vehicle mode to the first vehicle mode.

7. The vehicle system of claim 1, further comprising a display device, and wherein the instructions further cause the at least one processor to, in response to detecting the trigger event, cause the display device to display a prompt to the user of the personal vehicle, the prompt requesting the user to confirm that the user wishes to transition from the first vehicle mode to the second vehicle mode.

8. The vehicle system of claim 7, wherein the instructions further cause the at least one processor to receive a positive indication from the user in response to the prompt, and wherein the transition from the first vehicle mode to the second vehicle mode is in response to the positive indication.

9. The vehicle system of claim 7, wherein the instructions further cause the at least one processor to:
receive a negative indication from the user in response to the prompt; and
subsequent to receiving the negative indication, detect an override trigger event associated with the golf course;
wherein the transition from the first vehicle mode to the second vehicle mode is in response to detecting the override trigger event.

10. The vehicle system of claim 9, wherein the override trigger event is the personal vehicle sequentially traveling to multiple holes of the golf course.

11. The vehicle system of claim 1, further comprising a display device configured to be installed in the personal vehicle, and wherein the instructions, when executed by the at least one processor, further cause the at least one processor to:
cause the display device to display a first user interface associated with the first vehicle mode while the personal vehicle is in the first vehicle mode; and
cause the display device to display a second user interface associated with the second vehicle mode while the personal vehicle is in the second vehicle mode.

12. A vehicle system comprising:
a vehicle display device configured to be installed on a personal vehicle of a user, the vehicle display device including:
at least one processing circuit having at least one processor and at least one memory having instructions stored thereon that, when executed by the at least one processor, cause the at least one processor to:
display a first user interface associated with a first vehicle mode while the personal vehicle is in the first vehicle mode;
detect a trigger event associated with a golf course;
cause the personal vehicle to transition from the first vehicle mode to a second vehicle mode associated with the golf course based on detecting the trigger event, the personal vehicle having a first set of functionalities while in the first vehicle mode and a second set of functionalities while in the second vehicle mode, the second set of functionalities being different than the first set of functionalities and corresponding to at least one rule associated with the golf course; and
display a second user interface associated with the second vehicle mode while the personal vehicle is in the second vehicle mode.

13. The vehicle system of claim 12, wherein detecting the trigger event associated with the golf course comprises determining that a current time matches a tee time scheduled by the user associated with the personal vehicle.

14. The vehicle system of claim 13, wherein the instructions further cause the at least one processor to, in response to detecting the trigger event, display a prompt to the user of the personal vehicle, the prompt requesting the user to confirm that the user wishes to transition from the first vehicle mode to the second vehicle mode.

15. The vehicle system of claim 14, wherein the instructions further cause the at least one processor to receive a positive indication from the user via the first user interface in response to the prompt, and wherein the transition from the first vehicle mode to the second vehicle mode is in response to the positive indication.

16. A vehicle system comprising:
at least one processing circuit having at least one processor and at least one memory having instructions stored thereon that, when executed by the at least one processor, cause the at least one processor to:
detect a trigger event associated with a golf course while a vehicle of a user is in a personal use mode, wherein the vehicle is not trackable and not controllable by the golf course in the personal use mode; and
transition the vehicle from the personal use mode to a golf mode associated with the golf course based on detecting the trigger event, wherein the vehicle is at least one of trackable or controllable by the golf course in the golf mode;
wherein the at least one processing circuit includes at least one of (a) a first processing circuit configured to be located on the vehicle or (b) a second processing circuit configured to be located remote from the vehicle.

17. The vehicle system of claim 16, wherein the vehicle has a first set of functionalities while in the personal use mode and a second set of functionalities while in the golf mode, the second set of functionalities being different than the first set of functionalities and corresponding to at least one geofence-based rule associated with at least a portion of the golf course.

18. The vehicle system of claim 16, wherein detecting the trigger event associated with the golf course comprises detecting that the vehicle has entered a geofenced area associated with the golf course.

19. The vehicle system of claim 18, wherein detecting that the vehicle has entered a geofenced area associated with the golf course comprises detecting that the vehicle has entered and remained within the geofenced area for a predetermined amount of time.

20. The vehicle system of claim 19, wherein the predetermined amount of time is a first predetermined amount of time, and wherein the instructions further cause the at least one processor to:
detect that the vehicle has exited and remained outside of the geofenced area for a second predetermined amount of time; and
in response to detecting that the vehicle has exited and remained outside of the geofenced area for the second predetermined amount of time, transition from the golf mode to the personal use mode.
